(19) United States
(12) Patent Application Publication
(10) Pub. No.: US 2004/0153436 A1
(43) Pub. Date: Aug. 5, 2004

(54) Automated information management system and methods

(76) Inventors: Cameron A. Pope, Denver, CO (US); Zachary T. Nies, Arvada, CO (US); Mark W. Lemmons, Arvada, CO (US)

Correspondence Address: COCHRAN FREUND & YOUNG LLC, 3555 STANFORD ROAD, SUITE 230, FORT COLLINS, CO, 80525, US

(21) Appl. No.: 10/687,577

(22) Filed: Oct. 15, 2003

Related U.S. Application Data
(60) Provisional application No. 60/418,478, filed on Oct. 15, 2002.
(60) Provisional application No. 60/418,480, filed on Oct. 15, 2002.

(51) Int. Cl. G06F 7/00

(52) U.S. Cl. 707/1

(57) ABSTRACT

A method for managing a plurality of information resources in a computerized environment comprises collecting data relating to the plurality of information resources to determine relationships among the plurality of information resources, determining a current focus of the user, identifying information resources related to the current focus based on the determined relationships, and, making the identified information resources available for selection by the user.

### REFERENCE TO RELATED APPLICATIONS

This application claims priority from U.S. patent application Nos. 60/418,478 entitled “AUTOMATED INFORMATION MANAGEMENT SYSTEM AND METHODS” and 60/418,480 entitled “AUTOMATED SYSTEM FOR RANKING INFORMATION BASED ON RELEVANCE”, both filed 15 Oct. 2002, both of which are hereby incorporated by reference herein. The subject matter of this application is related to the subject matter of U.S. patent application Ser. Nos. 10/260,130 entitled “AUTOMATED SYSTEM AND METHOD FOR DETERMINING THE ACTIVITY FOCUS OF A USER IN A COMPUTERIZED ENVIRONMENT”, 10/260,152 entitled “AUTOMATED SYSTEM AND METHODS FOR COLLECTING DATA”, 10/260,173 entitled “AUTOMATED SYSTEM AND METHODS FOR DETERMINING RELATIONSHIPS BETWEEN INFORMATION RESOURCES” and 10/260,587 entitled “AUTOMATED SUPPORT OF USER INTERACTION WITH INFORMATION RESOURCES”, all of which were filed on 27 Sep. 2002.

### TECHNICAL FIELD

The invention relates to management of information in computerized environments, and more particularly to systems and methods for determining relationships between information resources, and for determining the relevance of information resources to a user.

### BACKGROUND

Computer systems can make available to a user a wide variety of information. Information which may be useful to a user may be contained in files of various formats such as word processing documents, spreadsheets, images, audio files, as well as in email messages or attachments thereto, address books, contact lists, database queries, and other sources, all of which are referred to herein as “information resources”. These information resources may be stored in various locations on a computer system.

To access an information resource, a user generally needs to know where on the computer system the information resource is stored. For example, a user can retrieve a file if the user knows the name of the file and which folder in a directory system the file is stored in. Most currently used operating systems provide search tools for finding files but these search tools can be time consuming and inconvenient to use, especially when the files in question may be stored in any of a wide range of locations. Further, tools for locating files stored in a file system typically cannot search effectively for e-mail messages, contacts, database records, or the like which may not be stored in individual files.

When a computer user is engaged in a specific task, referred to herein as the user's “current focus”, the user may wish to access various information resources. For example, if the user is sending an email, the user may wish to insert information from information resources available on the computer system into the email, or attach information resources as e-mail attachments. The user may also wish to send a copy of the email to another person, or include a copy of a previously received email in the current email. As another example, when the user is working on a file, the user may wish to include in the file data stored in other information resources such as messages or contact information. Such tasks can be tedious and time consuming, particularly when the user is not certain of the locations at which the desired information resources are stored or the user needs to access several information resources of various types for the current focus.

Examples of prior art attempts to assist computer users in retrieving information resources include U.S. Pat. No. 4,479,196 to Ferrer et al., U.S. Pat. No. 5,539,665 to Lamming et al., U.S. Pat. No. 5,794,178 to Caid et al., U.S. Pat. No. 5,835,905 to Pirolli et al., U.S. Pat. No. 5,873,107 to Borovoy et al., U.S. Pat. No. 6,236,768 to Rhodes et al. and U.S. Pat. No. 6,256,032 to Hugh.

There exists a need for systems and methods which facilitate the management of information resources by a user in a computerized environment.

### SUMMARY OF THE INVENTION

This invention has various aspects. The invention provides methods and systems for helping users of computer systems gain access to information resources which are relevant to the activity focus of the user.

One aspect of the invention provides a method for facilitating access to a plurality of information resources in a computerized environment. The method comprises collecting data relating to the plurality of information resources and determining relationships among the plurality of information resources wherein the information resources comprise information resources of a plurality of types; determining a current focus of a user, wherein the current focus is an information resource of one of the plurality of types; identifying information resources related to the current focus, the information resources related to the current focus comprising zero or more information resources of each of the plurality of types; and, separately making available for selection by the user the identified information resources of each of the plurality of types.

Another aspect of the invention provides a method for facilitating access to a plurality of information resources in a computerized environment. The information resources may comprise, for example, one or more of messages such as e-mail messages, files, persons (as represented by contact information) or the like. The method comprises: collecting data relating to the plurality of information resources and determining relationships among the plurality of information resources; monitoring activities of a user in the computerized environment to determine a current focus of the user; identifying information resources related to the current focus based on the determined relationships; and, making the identified information resources available for selection by the user.

In preferred embodiments, making the identified information resources available for selection comprises displaying representations of the identified information resources on a graphical user interface. The identified information resources may be updated to track changes in the current focus.

In systems and methods according to some specific embodiments of the invention, determining relationships among the plurality of information resources comprises identifying information resources which are messages in a conversation comprising a plurality of messages or are associated with messages in the conversation.

In systems and methods according to some specific embodiments of the invention, the information resources comprise information resources of a plurality of types and the current focus is an information resource of one of the plurality of types. In such methods, identifying information resources related to the current focus may comprise identifying at least one information resource of each of the plurality of types; and, making the identified information resources available for selection by the user may comprise separately making available the at least one identified information resource of each of the plurality of types. For example, the system or method may provide the user with access to a set of contact information for people related to the current focus, a set of messages related to the current focus, and a set of files related to the current focus.

Another aspect of the invention provides a method for locating a plurality of potentially relevant information resources in a computerized environment. The method comprises examining data relating to each one of the plurality information resources; determining relationships between the plurality of information resources based on a comparison of the examined data; and, arranging the plurality of information resources into a plurality of groups, each of the plurality of groups comprising a subset of the plurality of information resources that share at least one common criteria. The at least one common criteria may comprise at least one of lineage, structure, content, function, applied metadata and cross-references.

Another aspect of the invention provides a computer implemented system for facilitating access to a plurality of information resources in a computerized environment. The system comprises means for collecting data relating to the plurality of information resources and determining relationships among the plurality of information resources wherein the information resources comprise information resources of a plurality of types; means for determining a current focus of a user, wherein the current focus is an information resource of one of the plurality of types; means for identifying information resources related to the current focus, the information resources related to the current focus comprising zero or more information resources of each of the plurality of types; and, means for separately making available for selection by the user the identified information resources of each of the plurality of types.

Another aspect of the invention provides a system for determining relationships between information resources in a computerized environment. The system comprises a first component for examining data regarding the information resources; and, a second component for determining explicit relationships between the information resources by examining similarity of data between the information resources.

Another aspect of the invention provides a system for determining relationships between information resources in a computerized environment. The system comprises a first component for examining data and content regarding the information resources; and a second component for inferring relationships between information resources by comparing indirect data between the information resources.

Further aspects of the invention and features of specific embodiments of the invention are described below.

### BRIEF DESCRIPTION OF THE DRAWINGS

In drawings which illustrate non-limiting embodiments of the invention:

FIG. 1 is a schematic representation of a computer system according to one embodiment of the invention;

FIG. 2 is a block diagram of an information management system according to a preferred embodiment of the invention;

FIG. 3 is a flowchart illustrating a method of organizing information resources according to one embodiment of the invention;

FIG. 4A is a schematic representation of relationship data stored in a database according to one embodiment of the invention;

FIG. 4B is a schematic representation of relationships between information resources and the conversation of FIG. 4A;

FIG. 5 is a schematic representation of a contribution map generated by an analytic layer, according to one embodiment of the invention;

FIG. 6 is a flowchart illustrating a method of operation of an analytic layer according to one embodiment of the invention;

FIG. 7 is a flowchart illustrating the details of one block of FIG. 6;

FIG. 8 is a flowchart illustrating the details of another block of FIG. 6;

FIG. 9 is a flowchart illustrating the details of yet another block of FIG. 6;

FIG. 10 is a schematic representation of a graphic user interface (GUI) display according to one embodiment of the invention;

FIG. 11 shows the GUI display of FIG. 10 in an expanded condition; and,

FIG. 12 is a schematic representation of a GUI display according to another embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention provides methods and systems for assisting a user in locating and retrieving information resources in a computerized environment. Systems according to one embodiment of the invention collect data relating to available information resources and determine relationships among the information resources. Systems according to a preferred embodiment of the invention also rank the available information resources based on their relevance to a user's current focus. The information resources may be presented to the user in a manner which is organized according to their relevance.

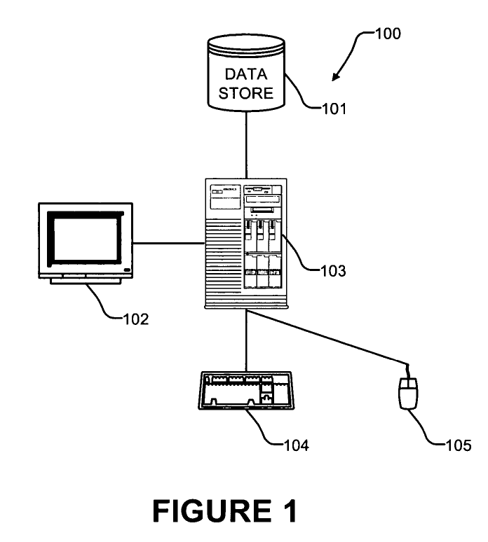

FIG. 1 shows a computer system 100 according to one embodiment of the invention. Computer system 100 includes an input device, which comprises a keyboard 104 and mouse 105 in the illustrated embodiment, and an output device, which comprises a monitor 102 in the illustrated embodiment, all connected to a data processor 103. Data processor 103 is has access to a data store 101. Data store 101 may comprise any combination of one or more local and/or remote data storage devices which may include disk drives, file servers, resources available by way of other data processors, a local area network, a wide area network, the internet, or other suitable devices.

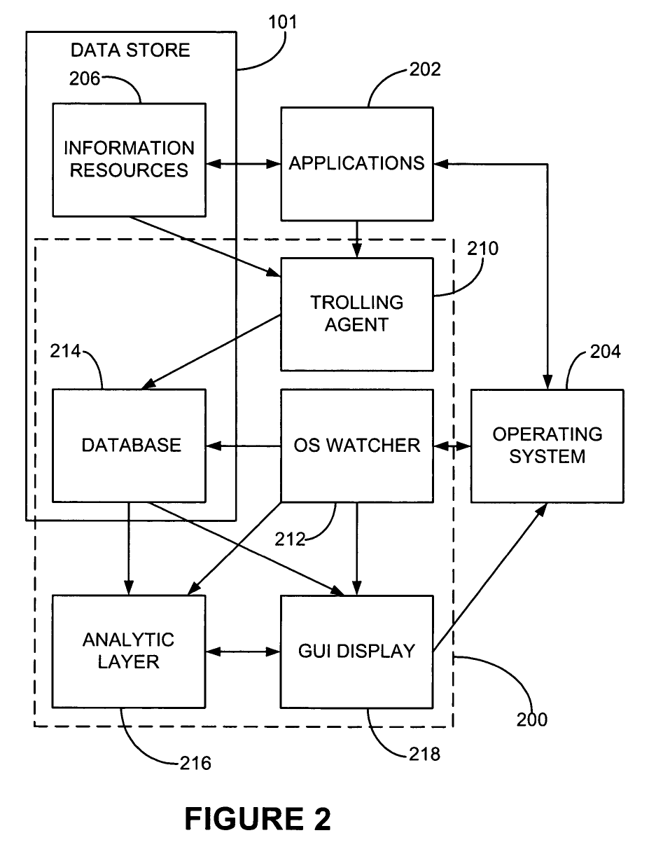

FIG. 2 illustrates an information management system 200 according to a preferred embodiment of the invention. System 200 runs on computer system 100. System 200 interacts with applications 202 and an operating system 204 running on computer system 100. System 200 provides a user with organized access to information resources 206 (such as files, messages, contacts, etc.) stored in data store 101. Information resources 206 may include resources within one or more databases, resources within one or more file systems, or both. Information resources 206 are available to computer system 100.

System 200 includes a trolling agent 210, an OS watcher 212, a database 214, an analytic layer 216, and a GUI display 218. Trolling agent 210 is configured to examine information resources 206 and applications 202 in order to determine relationships among information resources 206. Trolling agent 210 stores such relationships in database 214. OS watcher 212 is configured to monitor a user's interactions with operating system 204. From these interactions, OS watcher 212 determines the user's current focus. OS Watcher 212 may store information specifying the current focus in database 214, and also provide it directly to analytic layer 216 and GUI display 218.

Systems according to some embodiments of the invention permit a user to specify a focus, for example, by directly selecting a specific information resource to be a focus by way of a user interface. A user could use such functionality to set himself or herself as the current focus, thereby causing the system to display information resources most relevant to the user. Systems according to some embodiments of the invention permit a user to control the system to lock the current focus.

Database 214 is configured to provide information on relationships and focus to both analytic layer 216 and GUI display 218. Analytic layer 216 identifies available information resources that are related to the current focus. Analytic layer 216 causes representations of those information resources to be displayed on GUI display 218. In preferred embodiments, analytic layer 216 filters and sorts the information resources related to the current focus so that the relevant information resources are presented to the user in a way that is ordered based on relevance.

A user of system 200 is thereby presented on an ongoing basis with a selection of information resources which are relevant to the user's current focus. Information resources not determined to be sufficiently relevant to the current focus are excluded from the selection. The operation of the elements of system 200, and their interactions with one another and with computer system 100, are described in more detail below.

Some embodiments may not filter information resources 206 based on relevance. In such embodiments, GUI display 218 may display a list of all information resources identified in relationships and focus database 214 as being related to the current focus.

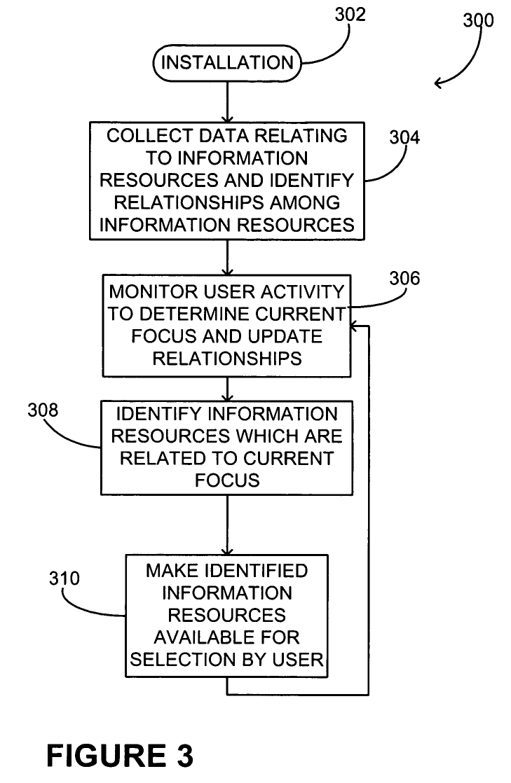

FIG. 3 illustrates a method 300 according to one embodiment of the invention. Method 300 begins with installation of system 200 on computer system 100 in block 302. In block 304 trolling agent 210 examines computer system 100 and collects data relating to information resources 206. Trolling agent 210 may obtain data relating to information resources 206 from one or more of:

information resources 206 themselves,

a file management system (which may be part of operating system 204), and

data stored in applications 202.

Trolling agent 210 uses the information to determine relationships among information resources 206. Trolling agent 210 stores indications of such relationships in database 214. Once trolling agent 210 has collected the data and determined the relationships in step 304, it may be configured to run in the background of computer system 100, either continually, periodically, or at the request of the user, in order to update the collected data and determined relationships in response to any changes to information resources 206. The operation of trolling agent 210 is described further below.

In block 306, OS watcher 212 monitors user activity occurring on computer system 100 in order to determine a current focus of the user. The current focus may be determined with regard to the application 202 being used by the user, the information resources 206 being accessed by the user, a history of the user's activity, or the like. Alternatively, the current focus may be input directly by the user. Some ways in which OS watcher 212 can determine the current focus are described below.

In block 308, the current focus identified in block 306 and the relationships identified in block 304 are used to identify information resources 206 which are related to the current focus. In block 310, the information resources identified in block 308 are made available for selection by the user, as described further below.

### Determining Relationships—Trolling Agent

Trolling agent 210 preferably constitutes means for collecting data relating to information resources and means for determining relationships among the information resources.

Trolling Agent 210 may identify both direct and indirect relationships among information resources 206. Direct relationships are based on characteristics and content specific to individual ones of information resources 206. Indirect relationships may be inferred or deduced based upon observations, assumptions, or knowledge about the information resources being related. Indirect relationships may depend upon chains of observations and are generally more tentative and subject to change based upon the addition of additional observations. Thus, indirect relationships are updated by trolling agent 210 as it operates, and may also be updated by OS watcher 212 as it monitors user activity, or by analytic layer 216 as it determines the relatedness and relevance of information resources 206 to the current focus, as described below. Direct and indirect relationships need not be in a hierarchical form.

Examples of direct relationships include:

lineage (parent/child/sibling relationships)

structural similarity;

similarity of content;

similarity of function;

similarity of applied metadata (time, creator, location, applied subject keywords); and,

linkage by reference.

Examples of indirect relationships include:

similarity of function or use: For example, a user may have more than one contact list or address book, and they may be used with different applications.

cause and effect: A series of events that appear to be related to each other via cause and effect are linked to each other by indirect relationships, which are based upon our assumptions about the nature of causation.

relatedness to common focus: As method 300 operates on computer system 100, various information resources which may not be directly related to each other may be identified as being related to a common focus. Trolling agent 210 may track some or all of these commonalities to identify new indirect relationships among information resources 206.

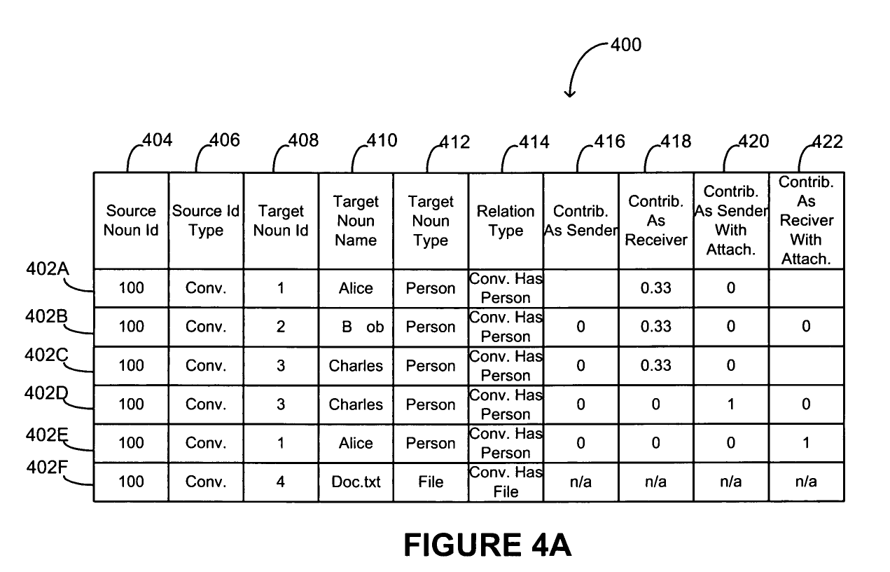

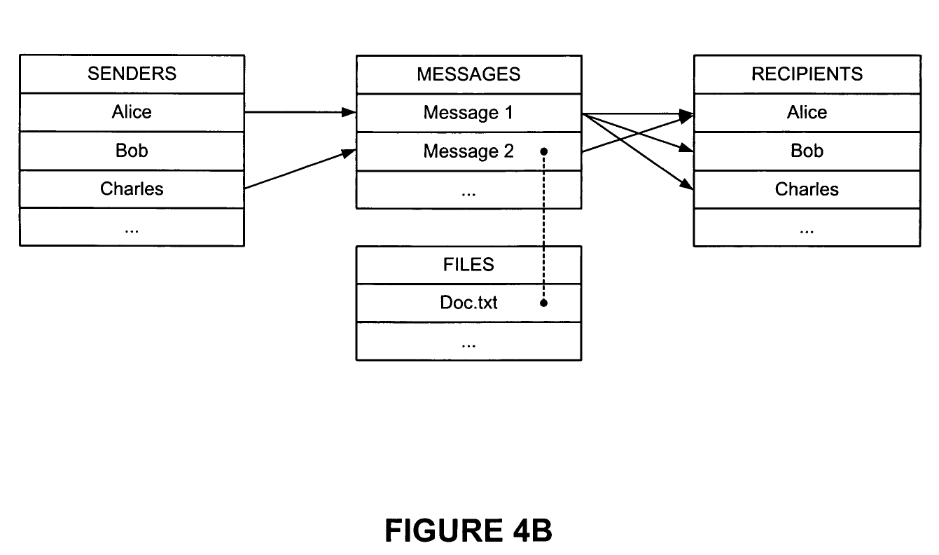

FIG. 4A illustrates an example of the type of relationship data 400 which may be stored in database 214 by trolling agent 210. Relationship data 400 contains a set of relationship entries 402A-402F, which represent how information resources, referred to in this context as “targets” are related to a specific information resource, referred to as a “source”. In the illustrated example, the source is a conversation, and relationship entries 402A-402F all relate to that conversation. A conversation is an information resource comprising a group of messages among which trolling agent 210 has inferred a relationship.

In a preferred embodiment, the member messages of a conversation are identified by examining each email message as it arrives and performing a hashing function on its “Subject” line. The hashed subject line (also referred to as the conversation identity) is stored as an attribute of a new message record in database 214. The conversation identity is also stored as a new entry in a list of conversations in database 214. System 200 may assume that messages having similar conversation identities are related to one another. Other methods for identifying messages that should be associated as a conversation may also be used.

In the example illustrated in FIG. 4A, relationship entries 402A-402C illustrate data derived from a single email message, sent without attachments, from Alice to Bob, Charles and herself. Relationship entries 402D-402F illustrate the data derived from a single email reply, sent with an attachment “Doc.txt”, from Charles to Alice. FIG. 4B is a schematic representation of the two messages which form the subject conversation of FIG. 4A. The meaning of the attribute values in the table of FIG. 4A are as follows:

Column 404 lists the source identity, which is the same for all entries 402A-402F since they all relate to a single conversation;

Column 406 indicates that the source for the relationships is a “conversation”;

Column 408 contains a unique identifier for each target related to the source (Alice=1, Bob=2, Charles=3, Doc.txt=4);

Column 410 contains the names of the targets;

Column 412 contains the types of the targets;

Column 414 indicates the type of relationship between the source and the targets; and,

Columns 416-422 indicate the contributions of each target to the source. In the context of messages, the contributions of each target are preferably normalized for each message. For example, column 418, which indicates contributions as a receiver of a message, contains the contribution value 0.33 for each of entries 402A-402C, since Alice, Bob and Charles all received the first message. Contribution values may be used by analytic layer 216 in certain embodiments of the invention, as described below.

It is to be understood that database 214 can also store other data relating to information resources 206, such as metadata, content of messages, digests of files or messages, contact information, or other information.

### Determining Focus—OS Watcher

To determine the current focus of the user, OS watcher 212 monitors actions of the user and operating system 204 to determine the user's current focus and usage patterns. OS watcher 212 preferably constitutes means for determining a current focus of the user. Examples of user actions that may be monitored by OS watcher 212 include:

keystrokes;

mouse clicks;

cursor movements;

spoken commands;

function calls;

error message generation;

file manipulations such as the creation, modification, deletion, copying, saving or moving of documents or messages;

the activity status of open application windows in a graphical user interface;

opening of a file;

closing of a program;

moving a window to the “front” in a graphical user interface;

movement of the cursor to the vicinity of an item;

in point and click systems, clicking on visual representations of items;

keystroke sequences corresponding to names or portions of names of specific information resources;

commands entered by the user;

exporting files; and,

saving email attachments.

It is important to note that the types of user activity that may be monitored in computer system 100 will vary with the configuration of computer system 100. The user activities and methods of monitoring them listed above are not a comprehensive list.

In a preferred embodiment of the invention, certain indicators of the user's current focus are chosen as triggers for information retrieval. The chosen triggers are preferably those that are most like an explicit request from the user to display or retrieve a specific item. Examples of such triggers include: clicking on a file to open or retrieve it, entering or selecting a name of a person or a file from a list, and, dragging and dropping a file into an application window.

Other indicators of current focus may be less certain, but nevertheless can be profitably logged and analyzed in order to produce additional measures of the relationships between the current focus and information resources 206. Such indications can be used to produce indicators of probable relatedness with respect to the current focus. An example of such an indicator is concurrently opened documents.

### Identifying Information Resources Related to the Current Focus

In one embodiment of the invention, identification of information resources 206 as being related to the current focus is accomplished by examining database 216 for all information resources 206 having a relationship entry pertaining to the current focus. However, as any computer user will appreciate, the list of information resources 206 on a computer system 100 which may be related to any given focus can be quite large. Presenting a user with such an unstructured list may, in some instances, make it more difficult for the user to locate desired information resources 206. Accordingly, another embodiment of the invention provides for the filtering and ordering of the identified information resources 206 based on relevance.

Returning to FIG. 2, analytic layer 216 identifies a set of information resources 206 which all have at least some relationship to the current focus. Analytic layer 216 preferably provides information identifying the resources 206 in the related set to GUI display 218 along with an indication of the number and type of relationship of each information resource on the list to the current focus.

Analytic layer 216 determines the degree of relatedness of any information resource 206 to the current focus by examining the relationship entries stored in database 214. As an example, if the current focus is a particular email message, one method of identifying relevant files may include examining all email messages that belong to the same conversation as the message of the current focus. The set of all files attached to any email message in the conversation may be used as a candidate set of related files. By examining the roles that various people played in the conversation one may assess the degree of relevance for each attached file.

Other relationships in the database that may lead from the message to other candidate files. In one embodiment, the choice of relationships to examine and the methods used to compute relevance are pre-determined. In other embodiments, these aspects may be configurable or may be automatically generated or combined or adapted as the system learns, based on user feedback, which methods produce the desired results.

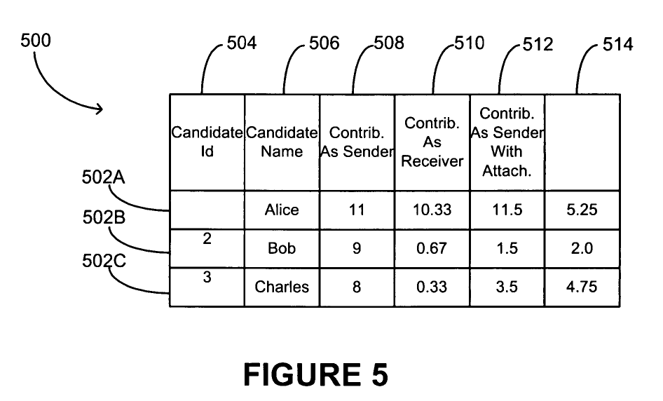

FIG. 5 illustrates a contribution map 500 generated by an analytic layer 216 according to a preferred embodiment of the invention. Contribution map 500 contains a set of candidate contribution entries 502A-502C. Contribution Map 500 is preferably a temporary data structure which is deleted by analytic layer 216 when no longer needed. Contribution Map 500 is indexed by candidate identity attributes of entries 502A-502C, which are stored in column 504 and uniquely identify each candidate. As relationships among information resources 206 are examined by system 200 in the process of determining relatedness, new relationship entries are created as new candidates are identified.

The name of each candidate is stored in column 506. Contributions each candidate has made as a sender, receiver, sender of an attachment, and receiver of an attachment, are stored in columns 508, 510, 512 and 514, respectively. The data stored in columns 508, 510, 512 and 514 may be weighted by analytic layer 216. For example, contribution map 500 shows Alice's contributions as a sender as having a value of 11. This could represent that Alice has sent 11 messages each having a weighting factor of 1, a single message with a weighting factor of 1, or some other combination of number of messages and weighting factors.

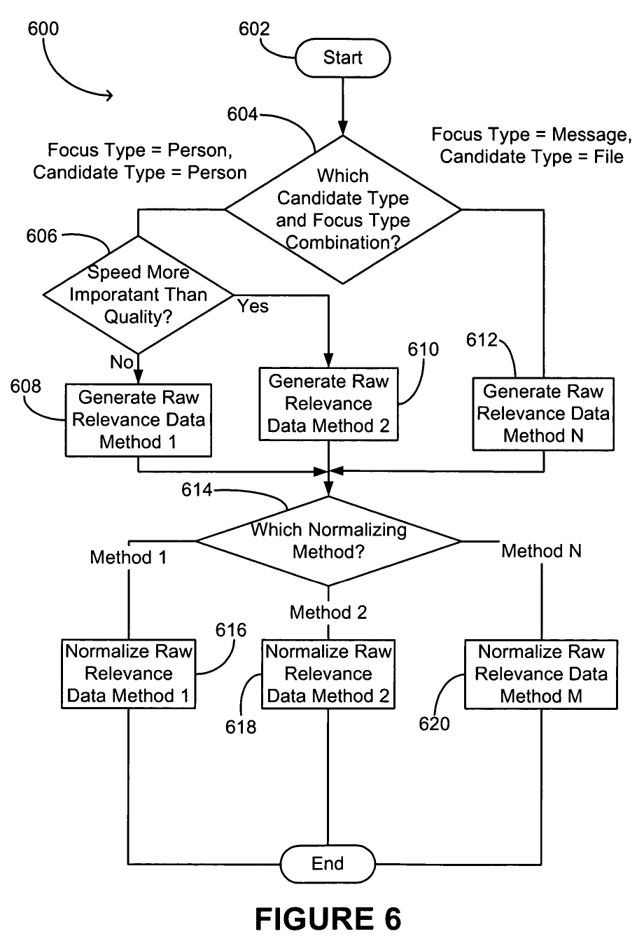

FIG. 6 is a flow chart illustrating a method 600 by which analytic layer 216 determines the degree of relatedness of information resources to the current focus according to a preferred embodiment of the invention. Method 600 begins in block 602, where analytic layer 216 receives the current focus and a list of information resources 206 related to the current focus from database 214. Method 600 is carried out for each information resource on the list, which are referred to as “candidates”.

In block 604, analytic layer 216 determines the types of information resources comprising the current focus and the candidate under consideration, which will impact on the method of determining relatedness selected by analytic layer 216.

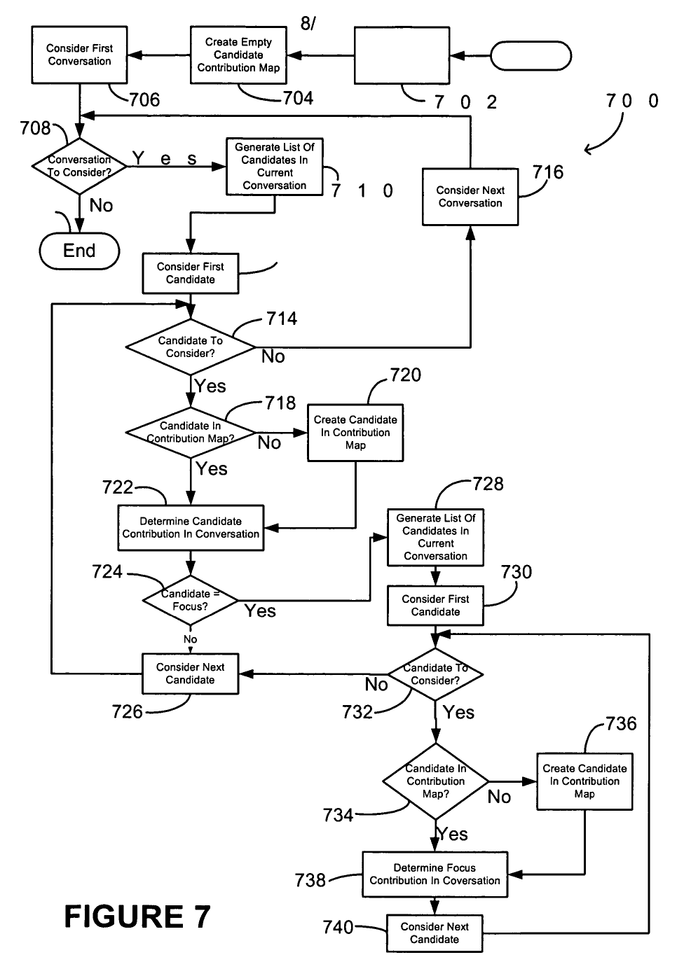

For example, when the focus and candidate types are both of type “person”, method 600 proceeds to block 606. In block 606, analytic layer 216 decides between speed and quality. Analytic layer 216 may make this decision based on the number of information resources and relationships that it must examine or on other criteria. When quality (i.e., accuracy and completeness) is preferred, method 600 proceeds to block 608 where it generates raw relevance data, as described further below with reference to FIG. 7. When speed is preferred, method 600 proceeds to block 610 where it generates raw relevance data, as described further below. If the focus and candidate types are not both “person”, method 600 proceeds to block 612. In block 612, analytic layer 216 generates raw relevance data. The raw relevance data may be generated in any of a wide variety of ways. For example, block 612 could employ both the methods of blocks 608 and 610 (and other methods) to generate raw relevance data.

For each candidate person, a set of contributions attributes such as those shown in columns 508, 510, 512 and 514 of FIG. 5 is provided for each conversation involving the focus person. Each attribute indicates a raw relatedness value for some aspect of the relationships examined. For example, one attribute may describe the aggregate role that a candidate person played as a sender in a set of conversations with the focus person. In other words, the more times the candidate person sent messages in the conversation involving the focus person, the higher the likelihood that the candidate person is relevant to the focus person.

Each of the methods in blocks 608, 610 and 612 provide raw relevance data for the candidates in the list provided to analytic layer 216.

The raw relevance data is normalized in blocks 614 to 620. In block 614, analytic layer 216 determines which method was used to obtain the raw relevance data, and selects an appropriate normalization method. Blocks 616, 618 and 620 represent normalization methods used for raw relevance data generated by the generation methods of blocks 608, 610 and 612, respectively.

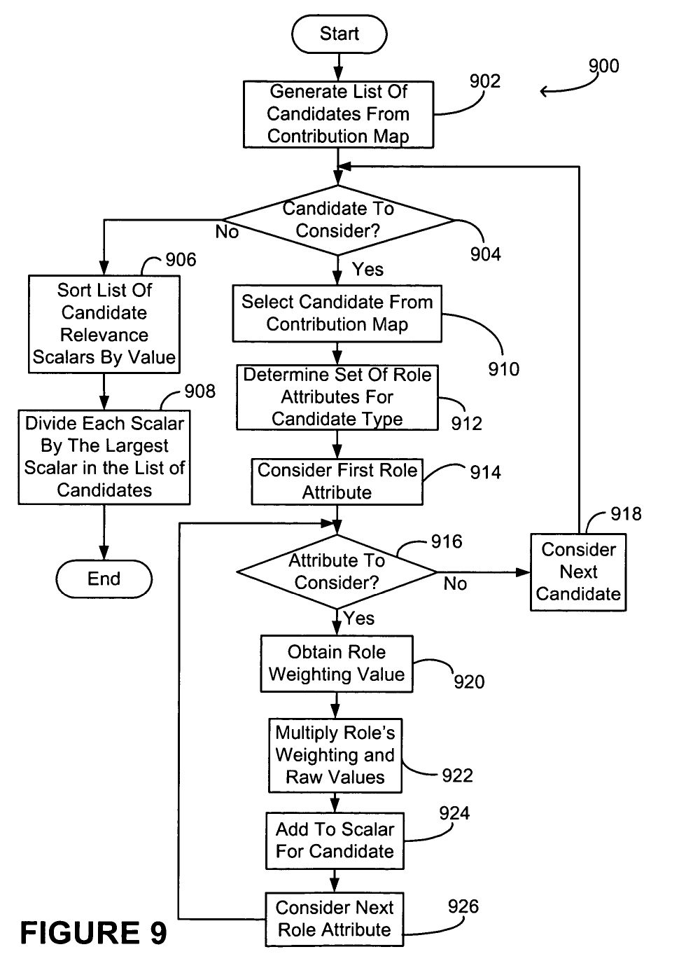

The method of block 616 is described further below with reference to FIG. 9 as an example of one possible normalization method. The method of block 618 is described further below in conjunction with the method of block 610.

FIG. 7 illustrates a method 700 employed in block 608 of FIG. 6. Method 700 examines the set of all email conversations that involved the focus person and determines from those conversations, the participants (candidates) and their role in each conversation. In block 702, analytic layer 216 identifies all conversations that were previously stored in database 214. The conversations related to the focus person are selected by querying database 214 for unique values of Source Noun Id 404 where Source Id Type 406 is “Conversation” and Target Noun Id 408 corresponds to the focus person (see FIG. 4).

In block 704, analytic layer 216 creates a new, empty contribution map 500 (see FIG. 5) to accumulate the raw relevance data in successive steps of method 700. In block 706, analytic layer 216 determines the first conversation from the list of stored conversations. In block 708, analytic layer 216 examines the conversation identity to ensure that the end of the list has not been reached. If there are no more conversations to consider, method 700 ends at block 709.

If there is still a conversation to be examined, in block 710 analytic layer 216 generates a list of candidates by examining the list of people referenced by the current conversation (query database 214 for unique Target Noun Id 408 where Source Noun Id 404 corresponds to the current conversation and Target Noun Type 412 corresponds to “Person”). In block 712, analytic layer 216 determines the first candidate in the list generated at step 710. In block 714, analytic layer 216 examines the candidate to ensure that the end of the list has not been reached. If there are no more candidates to consider, method 700 proceeds to block 716 where analytic layer 216 examines the next conversation in the list and the steps described above are repeated, starting at block 708.

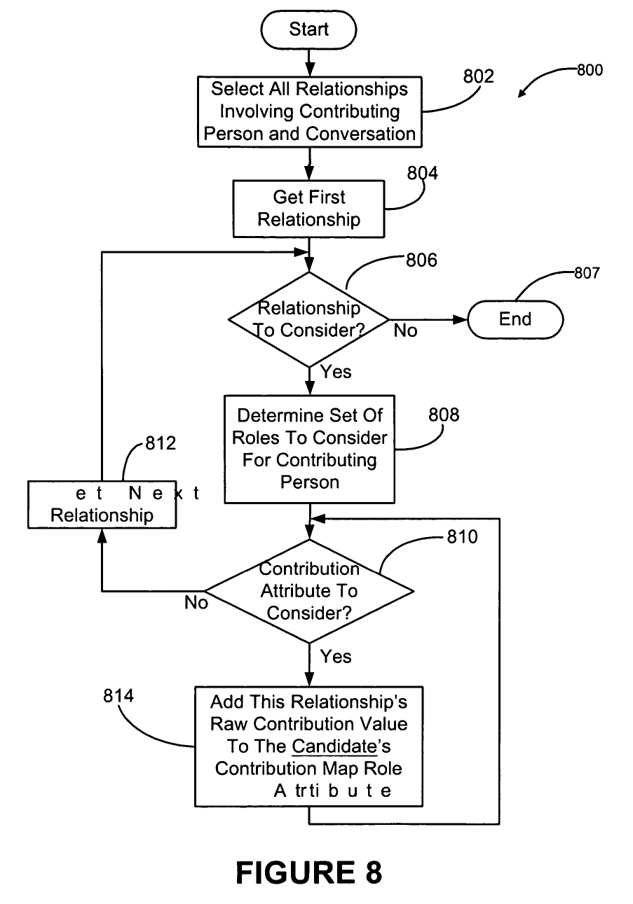

If there is still a candidate to be examined, at block 718, analytic layer 216 determines whether the candidate has an entry in contribution map 500. If no entry exists, analytic layer 216 creates an entry at step 720. When an entry exists, at step 722, analytic layer 216 determines the raw contribution that the current candidate made to the current conversation, as described further below with reference to FIG. 8.

In block 724, analytic layer 216 determines whether the current candidate is also the focus. If they are not the same person, analytic layer examines the next candidate in the current conversation at block 726, and the steps described above are repeated for the next candidate in the conversation starting at block 714.

If the candidate is also the person in focus, another series of steps is performed that adds the contributions of the focus to the contributions of the candidate. This increases the raw contribution of a candidate when he or she participated in a conversation where the focus contributed. In particular, the degree of focus contribution also directly affects the degree of the participating candidates' overall contribution.

In blocks 728 and 730, analytic layer 216 generates a list of candidates in the current conversation, as described above in relation to blocks 710 and 712. In block 732, analytic layer 216 determines the candidate name to ensure that the end of the list has not been reached. If there are no more candidates to consider, method 700 proceeds to block 726 and then block 714.

If there is still a candidate to be examined, at block 734 analytic layer 216 determines whether the candidate has an entry in contribution map 500. If no entry exists, analytic layer 216 creates an entry for the candidate in map 500 in block 736. When an entry exists, analytic layer 216 determines the raw contribution that the focus made to the current conversation at step 738, using the method of block 722, which is described below with reference to FIG. 8.

Next, in block 740, analytic layer 216 determines the next candidate in list and the steps described above are repeated beginning at block 732.

FIG. 8 illustrates a method 800 carried out by analytic layer 216 in blocks 722 and 738 of FIG. 7. In method 800 analytic layer computes the raw contribution of a person (a candidate) to a conversation and adds it to the specified candidate's entry in contribution map 500. In block 802, analytic layer 216 identifies a list of relationships between the specified conversation and person. This may be accomplished by querying database 214 for entries where the value of attribute Source Noun Id 404 corresponds to the specified conversation identity and the value of attribute Target Noun Id 408 corresponds to the identity of the contributing person.

In block 804, analytic layer 216 considers the first relationship in the list. In block 806, analytic layer 216 examines the relationship. If there is no relationship to consider, method 800 ends at block 807. If there is a relationship to consider, analytic layer 216 identifies the set of contribution attributes to consider for the relationship in block 808. In a preferred embodiment, method 800 considers a predefined set of contribution attributes such as sender, recipient, sender with attachment, recipient with attachment (e.g., columns 416, 418, 420 and 422 of relationship data 400) stored with the relationship. In other embodiments, the contribution attributes used by method 800 may differ for different relationships. In such embodiments, the contribution attributes may be determined by the relationship or its type or otherwise configured.

In block 810, analytic layer 216 examines the contribution attributes of the set of contribution attributes identified in block 808. If block 810 determines that there are no more contribution attributes to consider, analytic layer 216 examines the next relationship in the list in block 812. Method 800 then processes the next relationship, as described above, beginning at block 806.

If block 810 determines that there is one or more contribution attributes to consider then method 800 proceeds to block 814. In block 814, analytic layer 216 adds the value of the contribution attribute for the current relationship to the similarly named attribute in the current candidate's entry 502 in contribution map 500. Method 800 then returns to step 810 and determines whether there are any more contribution attributes to consider for the relationship being processed.

FIG. 9 illustrates a method 900 carried out by analytic layer 216 in block 616 of FIG. 6. In method 900, analytic layer normalizes each of the raw entries in contribution map 500. Method 900 derives a scalar value for each candidate's contribution and normalizes the scalar value to be in the range of 0% to 100%. The normalized scalar values for a group of candidates represent the degree of relatedness of each of the candidates to the focus relative to the other candidates. The candidate most related to the current focus is the most (100%) relevant.

One way to compute the scalar values is to take a weighted sum of all of the raw contribution role values. Different attributes may be weighted differently in the weighted sum to take into account the fact that different attributes have different correlations to the relatedness of a candidate to a conversation (e.g. sending may be a more important indicator of relatedness than receiving; being a named recipient may be a more important indicator of relatedness than being named as a recipient of a cc:). Any form of computation of contribution attributes, weighting values or other information may be used to compute the scalar values.

In block 902, analytic layer 216 generates a list of candidates by examining the list of candidates in contribution map 500. Analytic layer 216 allocates a scalar variable, initially zeroed, for each candidate in the list to hold the combined contribution of that candidate. In block 904, analytic layer 216 gets the next candidate in the list. If there are no more candidates to process, analytic layer 216 sorts the list of candidate scalar values in block 906 in order of the scalar values. In block 908, analytic layer 216 finds the largest scalar value in the list and divides each scalar value by the largest scalar value to yield a set of normalized scalar values ranging between 0 and 1. The product of method 900 is a list of candidate identities and their scalar values, which may be supplied to GUI display 218.

If, in block 904, analytic layer 216 determines there is another candidate to consider then method 900 proceeds to block 910 where it selects the entry for that candidate from contribution map 500. In blocks 912 and 914, analytic layer 216 determines the set of contribution attributes for the candidate (e.g. analytic layer 216 retrieves values from columns 508, 510, 512 and 514 of map 500 in the row corresponding to the candidate). Method 900 then takes the first attribute. Block 916 determines whether there is an attribute to consider. If there is no attribute to consider method 900 proceeds to block 918 to process the next candidate in the list as described above beginning at block 904.

If block 916 determines that there is an attribute to consider, analytic layer 216 obtains the attribute value corresponding to the current candidate from contribution map 500 in block 920. In block 922, analytic layer 216 obtains a role contribution weighting value, corresponding to the contribution attribute, and multiples the candidate's contribution value by the weighting value. The weighting value may be pre-determined or configurable.

In block 924, analytic layer 216 adds the resulting value, to the scalar variable allocated to the candidate. In block 926, analytic layer 216 considers the next candidate in the list and proceeds to process the next candidate in the list as described above, beginning at block 916.

Method 600 of FIG. 6 contemplates that alternative methods for computing relevance may be carried out in blocks 610 and 618. Blocks 610 and 618 produce relevance measures with less computation than blocks 608 and 616 which are described above. For example, block 610 may compute raw relevance in two steps. The first step identifies contributions by candidates that sent messages to the focus person. The second step identifies contributions by the focus person in sending messages to the candidate.

For each step, the contributions from each candidate are normalized by dividing it by the largest contributor. The normalized contributions for each candidate of the first and second steps are computed and normalized in block 618 to a scalar according to an equation such as:

(Contribution as Sender to Focus+(W×Contribution as Receiver from Focus))/(1+W) (1)

Where W is a coefficient that expresses the relative importance of being a sender of messages in a conversation and being a receiver of messages in the conversation to the relatedness between the candidate and the conversation. Thus, if a candidate has sent many messages to the focus, but has not received any messages from the focus, that candidate's relevance is reduced. In some embodiments, W is set to 2. Different relationships, characterizing the relationship of people to messages may be used to derive equations which may be used in place of equation (1).

The methods described above are example methods used by analytic layer 216 to determine the relevance of information resources 206 to the current focus when both the resources and the focus are people. For any combination of a focus and candidate, there may be many methods to compute the relevance. Different methods will have different advantages and disadvantages. The following paragraphs outline example approaches for other combinations of information resource types to further illustrate preferred embodiments of the invention.

Message—Person Methods: Where the current focus is a message, an example method for identifying people who are most relevant to the message is similar to the method shown in FIGS. 7 to 9. In this case, however, analytic layer 216 selects a conversation by querying the message entity record to obtain the conversation identity.

Message—File Methods: Where the current focus is a message, an example method for identifying files most relevant to the message starts by finding the conversation to which that message belongs. The method then identifies all files attached to all messages in the conversation. This may be accomplished by first selecting all of the entries from database 214 where Source Noun Id 404 corresponds to the conversation. Then, the selected entries are queried to find the files identified by Target Noun Name 410 where Target Noun Type 412 is “File”.

In a preferred embodiment, the list of all files in the computer system 100 is also searched by name for files having names similar to any of the files attached to messages in the conversation. The method then proceeds to compute a measure of relevance for each file.

The relevance measures are higher for files related by attachment than for files related by similar names. The relevance measures for files related by similar names may be based upon a degree to which the files names are similar to the name of an attached file. All the relevance measures may also be scaled based on how far in the past the file was modified. More recently modified files may be given higher relevance measures than files which have not been modified for a long time.

Message—Message Methods: Where the current focus is a message, an example method for finding relevant messages uses two factors in determining relevance. A set of candidate messages is the messages in the same conversation as the focus message. A first factor which may be used to generate a relevance measure for the candidate messages is based on time. The contribution of a message decreases with its age. The most recent messages have higher contributions. Older messages have smaller contributions.

A second factor is the relevance of the message sender to the user, in the context of the message-referenced conversation (e.g. similar to Person-Person but within the scope of a single conversation).

File—Person Methods: Where the current focus is a file, an example method for finding relevant people is similar to that shown in FIGS. 7 to 9. In this case, however, the conversations selected by analytic layer in block 702 may be determined by querying database 214 for unique values of Source Noun Id 404 where Source Id Type 406 is “Conversation” and Target Noun Id 408 corresponds to the file in focus.

File—File Methods: Where the current focus is a file, an example method for finding relevant files begins by finding the conversations where the focus file was an attachment. The method continues by finding other attached files in those conversations. In one preferred embodiment, each found file in the list is matched against all other known files in the computer system 100 in a search for files with similar names. A relevance measure is then determined for each candidate file. The relevance measure is higher for candidate files related by attachment than it is for candidate files which merely have names similar to those of attached files. A file related by similar name is given a relevance measure proportionate to the degree to which the name is similar to an attached file.

All of the relevance measures may be scaled based on how far in the past the candidate file was modified and/or sent.

File—Message Methods: Where the current focus is a file, an example method for finding relevant messages builds a list of candidate messages by taking all messages in any conversations in which the focus file was an attachment. Two factors may be used in determining the relevance of candidate messages. A first factor is based upon time. The contribution of a message decreases with its age. The most recent messages have higher contributions. Older messages have lower contributions. A second factor is the relevance of the message sender to the user, in the context of all the file-referenced conversations.

Person—File Methods: Where the current focus is a person, an example method for finding files starts by finding all of the conversations the focus person has participated in. A list of candidate files can be built by taking all of the files referenced by attachment in all of the messages contained in all of those conversations. In one preferred embodiment, each candidate file in the list is matched against all other known files in system 100 to find additional candidate files with names similar to the files.

A relevance measure is then determined for each candidate file. Within the group of files related by attachment, files in a first group of files attached to messages sent by the person in the focus field are given highest relevance. Other files related by attachment to messages in the conversation are given lower relevance. Files related by similar name are given relevance proportionate to the degree to which their names are similar to the name of an attached file. All of the relevance scores may be scaled based on how far in the past the file in question was modified.

Person—Message Methods: Where the current focus is a person, an example method for finding messages starts by finding all of the conversations in which the focus person participated. Of the messages in the conversation, the ones sent by the focus person to only one recipient are given the highest relevance. Next highest are messages from the focus person to a group of persons. Next highest are messages sent by others. These three categories of messages may optionally be presented to the user as three separate groups. All the relevance scores may be scaled based on how far in the past the message was sent.

### Making Information Resources Available—GUI Display

In a preferred embodiment, information management system 200 is used in a computer system 100 with a monitor 102, which displays GUI display 218 to the user. GUI display 218 preferably constitutes a means for making information resources related to the current focus available for selection by the user.

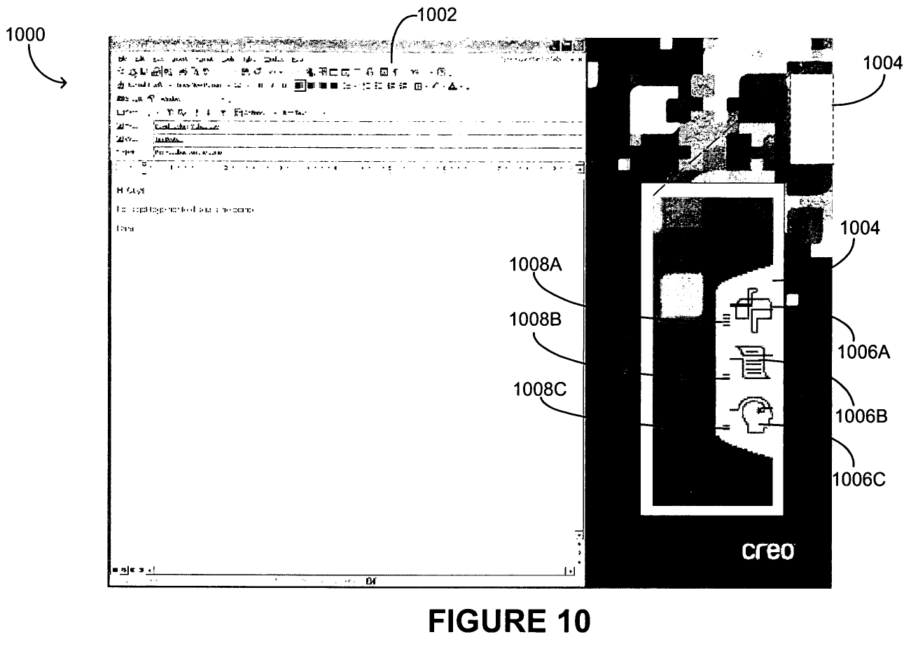

FIG. 10 depicts a screen 1000 of monitor 102 displaying a first display mode of GUI display 218 according to one embodiment of the invention. An application window 1002 being used by the user is displayed on screen 1000. When in its first display mode, GUI display 218 comprises a status bar 1004 at an edge of screen 1000. Status bar 1004 displays icons 1006 for various categories of information resources, as well as quantity indicators 1008, which represent the number of information resources or each category identified as related to the current focus. Status bar 1004 occupies a small amount of area on screen 1000 and provides an unobtrusive cue to the user about the amount of information resources related to the current focus.

In the FIG. 10 embodiment, icons 1006A-1006C represent messages, files, and people, respectively, and indicators 1008A-1008C represent the number of identified information resources 206 in these categories. The invention is not limited to these categories.

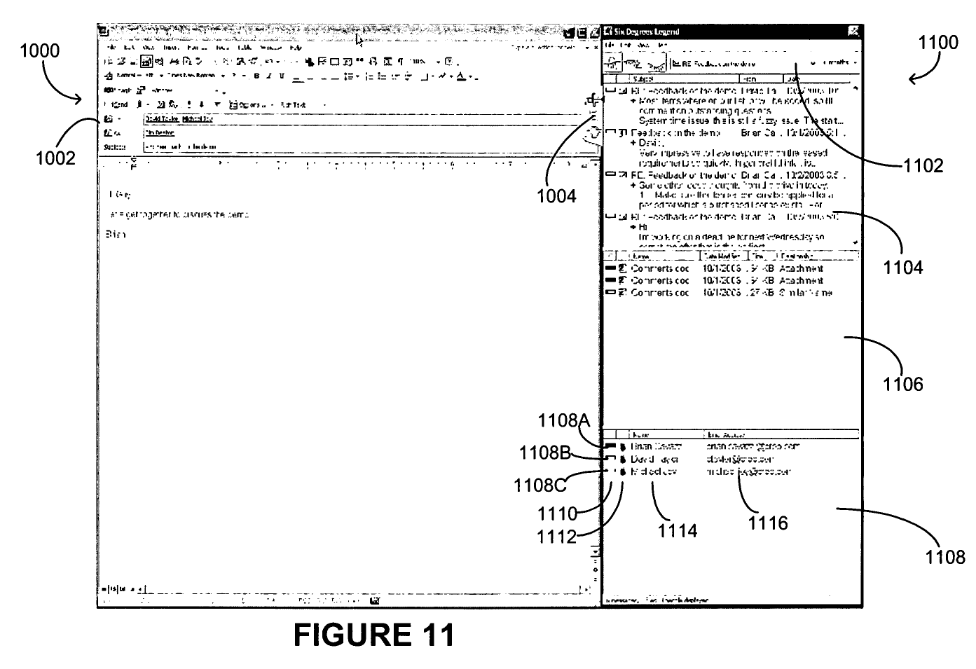

When a user wishes to explore the information resources 206 related to the current focus the user may use mouse 105 to point at the status bar 1004. This causes GUI display 218 to expand to display legend 1100, as shown in FIG. 11. Legend 1100 provides an expanded view of the information resources 206 related to the current focus, which is preferably displayed in field 1102. Optionally, the user is able to manually alter the current focus by means of a drop down menu in field 1102, or may lock the current focus to the focus displayed in field 1102.

Legend 1100 comprises a message pane 1104, a file pane 1106 and a people pane 1108. Each pane 1104, 1106, 1108 comprises a list of information resources 206 of the same type along with additional attributes of each information resource. As an example, person pane 1108 contains three relevant people, 1108A-1108C. For each person 1108A-1108C, relevance symbol 1110, linkage symbol 1112, name 1114, and address 1116 are displayed to indicate attributes of the people.

Relevance symbol 1110 preferably comprises a horizontal bar whose fill level indicates the degree of relatedness of the person identified by name 1114, and is generated by analytic layer 216. The entries in the person pane 1108 are sorted by one of the attributes 1110, 1112, 1114 or 1116. In the FIG. 11 example, relevance 1110 is the sorting attribute. The user may use the mouse 105 to change the sorting attribute and may also launch an application associated with the entry by clicking on linkage symbol 1112 (for example launching a new message to the selected person). The other panes 1104 and 1106 contain similar information corresponding to messages and files, respectively.

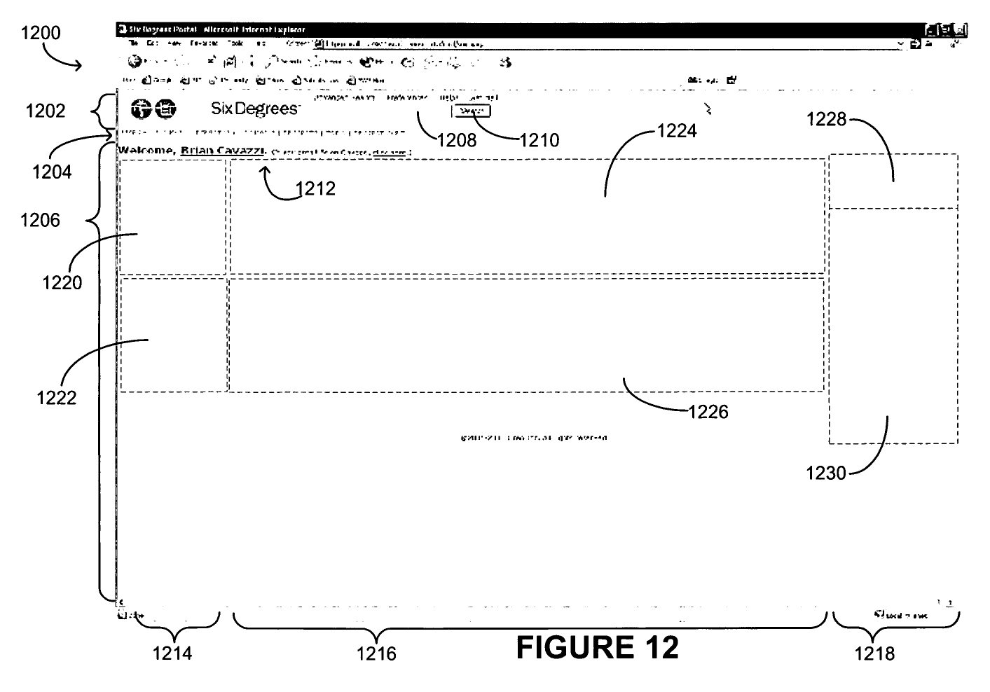

FIG. 12 depicts a GUI display 218 according to another embodiment of the invention. In the FIG. 12 embodiment, GUI display 218 comprises a portal 1200 enclosed within a window on monitor 102. Portal 1200 comprises a title pane 1202, a views pane 1204, and an information pane 1206. Title pane 1202 includes a focus input field 1208 and search button 1210. The user may select a focus by entering a partial text string in focus input field 1208 and selecting search button 1210.

Views pane 1204 indicates a list of view selection symbols. The user may use mouse 105 to select one of the symbols in views pane 1204, which causes portal 1200 to present an alternate information pane 1206 corresponding to the selected view.

Information pane 1206 comprises a current focus symbol 1212, a people pane 1214, a messages pane 1216, and a files pane 1218. Other information panes 1206, corresponding to different views, may have a different organizational structure. However, the concepts described for the illustrated view apply to the other views as well, the other view need not be described.

People pane 1214 comprises a my contributors pane 1220 and a recent contributors pane 1222. Both my contributors pane 1220 and recent contributors pane 1222 include a list of related people generated by analytic layer 216. My contributors pane 1220 preferably displays a list which has been filtered and sorted by analytic layer 216 to include only the most relevant people over a significant period of time, listed in order of their degree of relevance. Recent contributors pane 1222 preferably displays a list which has been filtered and sorted by analytic layer 216 to include only the most relevant people over a recent period of time, listed in order of their degree of relevance.

Messages pane 1216 comprises a from my contributors pane 1224 and an only to me pane 1226, both of which include a list of related messages generated by analytic layer 216. From my contributors pane 1224 preferably displays a list which has been filtered and sorted by analytic layer 216 to include only those involving the participation of people listed in my contributors pane 1220 and having a high degree of relevance. Only to me pane 1226 preferably displays a list which has been filtered and sorted by analytic layer 216 to include those that were sent only to the person identified in current focus symbol 1212 and having a high degree of relevance.

Files pane 1218 comprises a recent attachments pane 1228 and a recent files pane 1230, both of which include a list of related files generated by analytic layer 216. Recent attachments pane 1228 preferably displays a list which has been filtered and sorted by analytic layer 216 to include only those having been sent or received as attachments within a recent period and having a high degree of relevance. Recent files pane 1230 preferably displays a list which has been filtered and sorted by analytic layer 216 to include only those files which have recently been modified and having a high degree of relevance.

GUI display 218, in one preferred embodiment of the invention, allows the user to add or sever relationships with a focus. As an example, the relevance of people listed in my contributors pane 1220 may be initially computed using the methods described above. GUI display 218 provides a method for the user to explicitly exclude people from or add people to my contributors pane 1220. This new data may then be used in additional steps of the methods of analytic layer 216 or may be used to augment and/or filter information in GUI display 218. It is understood that other methods, including but not limited to, altering the stored records of entities and relationships in database 214 may be supported by GUI display 218 so that analytic layer 216 produces the results desired by the user.

In addition to being able to change the current focus using the focus input field 1208, the user can change the current focus by selecting any of the people, messages, or files displayed in any of panes 1214, 1216 or 1218.

Portal 1200 is configured to operate in the context of a web browser and thus has the advantage of a familiar interaction paradigm. It also has the advantage of providing a variety of views of relatedness among information resources 206 based on different methods of computing the relatedness. It also has the advantage of being able to use the information from one view to sort and filter information in another view (e.g. presenting messages filtered by historically or recently important people). Portal 1200 also has the advantage of being able to launch a native application associated with a displayed information resource. This ensures that the user's focus on related information resources is not lost while using the launched application.

Other types of user input and output means may be used as well. It is also understood that presentation of other information resource attributes and types in GUI Display 218 is within the scope of the invention. It is also understood that different methods of organizing (e.g. filtering, sorting, displaying) the information resource presentation is within the scope of the invention It is also understood that entities other than a user (e.g. a computerized system or application) may interact with system 200 to establish a current focus and obtain relevant information resource information.

Certain implementations of the invention comprise computer processors which execute software instructions which cause the processors to perform a method of the invention. The invention may also be provided in the form of a program product. The program product may comprise any medium which carries a set of computer-readable signals comprising instructions which, when executed by a computer processor, cause the data processor to provide a system according to the invention or to execute a method of the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. Software instructions on the program product may be stored in an encrypted and/or compressed format.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for facilitating access to a plurality of information resources in a computerized environment, the method comprising:
collecting data relating to the plurality of information resources and determining relationships among the plurality of information resources wherein the information resources comprise information resources of a plurality of types;
determining a current focus of a user, wherein the current focus is an information resource of one of the plurality of types;
identifying information resources related to the current focus, the information resources related to the current focus comprising zero or more information resources of each of the plurality of types; and,
separately making available for selection by the user the identified information resources of each of the plurality of types.

2. A method according to claim 1 wherein determining the current focus comprises monitoring activities of the user in the computerized environment.

3. A method according to claim 1 wherein determining the current focus comprises receiving a user input specifying the current focus

4. A method according to claim 1 wherein collecting data relating to the plurality of information resources comprises periodically collecting data on at least one of lineage, structure, content, function, applied metadata and cross-references of the plurality of information resources.

5. A method according to claim 1 wherein determining relationships among the plurality of information resources comprises identifying information resources which are either messages in a conversation comprising a plurality of messages or are associated with messages in the conversation.

6. A method according to claim 1 wherein identifying information resources related to the current focus comprises locating information resources having at least one relationship to the current focus.

7. A method according to claim 1 wherein the plurality of types include messages, people and files.

8. A method according to claim 7 wherein the current focus comprises a focus person and identifying files relevant to the focus person comprises:
identifying conversations in which the focus person has participated; and,
identifying files attached to messages in the conversations in which the focus person has participated.

9. A method according to claim 8 wherein identifying files relevant to the focus person also comprises identifying at least one file having a name similar to a name of at least one of the files attached to the messages in the conversations.

10. A method according to claim 7 wherein the current focus comprises a focus person and identifying messages relevant to the focus person comprises:
identifying conversations in which the focus person has participated; and,
identifying messages in the conversations in which the focus person has participated.

11. A method according to claim 7 wherein the current focus comprises a focus person and identifying persons relevant to the focus person comprises:
identifying conversations in which the focus person has participated; and,
identifying other persons who have participated in the conversations in which the focus person has participated.

12. A method according to claim 7 wherein the current focus comprises a focus file and identifying persons relevant to the focus file comprises:
identifying conversations in which the focus file has been attached to at least one message; and,
identifying persons who have participated in the conversations in which the focus file has been attached to at least one message.

13. A method according to claim 7 wherein the current focus comprises a focus file and identifying messages relevant to the focus file comprises:
identifying conversations in which the focus file has been attached to at least one message; and,
identifying messages in the identified conversations.

14. A method according to claim 7 wherein the current focus comprises a focus file and identifying files relevant to the focus file comprises:
identifying one or more conversations in which the focus file has been attached to at least one message; and,
identifying other files which have been attached to at least one message in the identified conversations.

15. A method according to claim 14 wherein identifying files relevant to the focus file also comprises identifying at least one file having a name similar to a name of at least one of the files attached to the messages in the identified conversations.

16. A method according to claim 7 wherein the current focus comprises a focus message and identifying persons relevant to the focus message comprises:
identifying a conversation to which the focus message belongs; and,
identifying persons who have participated in the identified conversation.

17. A method according to claim 7 wherein the current focus comprises a focus message and identifying messages relevant to the focus message comprises:
identifying a conversation to which the focus message belongs; and,
identifying other messages in the identified conversation.

18. A method according to claim 7 wherein the current focus comprises a focus message and identifying files relevant to the focus message comprises:
identifying a conversation to which the focus message belongs; and,
identifying files attached to messages in the identified conversation.

19. A method according to claim 18 wherein identifying files relevant to the focus file also comprises identifying at least one file having a name similar to a name of at least one of the files attached to the messages in the identified conversation.

20. A method according to claim 1 wherein identifying information resources related to the current focus comprises locating information resources having a predetermined type of relationship to the current focus.

21. A method according to claim 1 wherein making the identified information resources available for selection by the user comprises displaying representations of the identified information resources in a display of the computer environment.

22. A method according to claim 21 comprising automatically updating the identified information as the current focus changes.

23. A method according to claim 1 wherein identifying information resources related to the current focus comprises determining a relevance of each of the information resources to the current focus.

24. A method according to claim 23 wherein determining a relevance of each of the information resources to the current focus comprises, for at least some of the information resources, examining each of a plurality of relationships between the information resource and the current focus, the plurality of relationships including relationships of different types, assigning different weights corresponding to the different types of relationships and computing a relevance measure for each of the information resources based upon the plurality of relationships and the corresponding weights.

25. A method according to claim 23 wherein determining a relevance of each of the information resources to the current focus comprises identifying at least one conversation associated with the current focus, the conversation comprising a plurality of messages, the current focus comprising one of the messages or an information resource associated with one of the messages in the conversation and determining a relevance of each of the information resources to the conversation.

26. A method according to claim 25 wherein each of the information resources can have any of a plurality of roles in relation to the messages of the conversation and determining a relevance of each of the information resources to the conversation comprises computing a raw value based on a weighted sum of the number of times that each of the information resources has each one of the plurality of roles in relation to the messages of the conversation.

27. A method according to claim 26 comprising normalizing the raw values for each of the information resources.

28. A method according to claim 27 wherein the information resources are persons, and the plurality of roles includes at least sending messages in the conversation and receiving messages in the conversation.

29. A method according to claim 28 wherein, in computing the weighted sum, sending messages is weighted more heavily than receiving messages.

30. A method according to claim 11 wherein identifying persons relevant to the focus person comprises determining a relevance of each of the relevant persons to the current focus person.

31. A method according to claim 30 wherein determining the relevance of each of the relevant persons comprises examining one or more interactions between each of the relevant persons and the focus person wherein, in each of the interactions, the relevant persons have one or more or a plurality of roles in the interaction, providing a weighting factor corresponding to each of the plurality of roles; and,
computing a relevance measure for each of the relevant persons based upon the interactions between that relevant person and the focus person, the corresponding roles of the relevant person and the corresponding weighting factors.

32. A method according to claim 31 wherein determining the relevance of each of the relevant persons comprises performing the computation:
(CS+(W×CR))/(1+W)
or a mathematical equivalent thereof, where CS is a number based upon a number of times that the relevant person contributed as a sender of a message to the focus person, CR is a number based upon a number of times that the relevant person contributed as a receiver of messages from the focus person and W is a weighting factor.

33. A method according to claim 1 wherein making the identified information resources available for selection by the user comprises displaying representations of the information resources in a graphical user interface.

34. A method according to claim 8 wherein making the identified information resources available for selection by the user comprises displaying representations of the identified information resources in a graphical user interface.

35. A method according to claim 33 wherein identifying information resources related to the current focus comprises computing a measure of relevance of each of the information resources to the current focus.

36. A method according to claim 35 wherein displaying the representations, of the identified information resources in the graphical user interface comprises displaying the representations in an order dependent upon the measures of relevance of the information resources.

37. A method according to claim 36 wherein displaying the representations comprises displaying representations corresponding to each of the plurality of types in a corresponding one of a plurality of areas of the graphical user interface.

38. A method according to claim 35 wherein computing the measure of relevance of each of the information resources to the current focus comprises identifying at least one conversation associated with the current focus, the conversation comprising a plurality of messages, the current focus comprising one of the messages or an information resource associated with one of the messages in the conversation and determining a relevance of each of the information resources to the conversation.

39. A method according to claim 38 wherein each of the information resources can have any of a plurality of roles in relation to the messages of the conversation and determining a relevance of each of the information resources to the conversation comprises computing a raw value based on a weighted sum of the number of times that each of the information resources has each one of the plurality of roles in relation to the messages of the conversation.

39. A method for determining relationships between information resources in a computerized environment, said method comprising:
examining data and content regarding said information resources; and,
inferring relationships between information resources by comparing indirect data between said information resources.

40. A method according to claim 39 wherein said step of inferring relationships between information resources includes:
comparing data other than the content of the information resources.

41. A method according to claim 39 wherein inferring relationships between the information resources includes:
comparing data other than the characteristics of the information resources.

42. A method for organizing information relating to a user activity in a computerized environment, the method comprising:
automatically collecting data regarding information resources available in the computerized environment;
determining relationships between the information resources;
determining a user activity focus;
organizing each of the information resources relating to the user activity focus; and,
determining relative relevances of the organized information resources.

43. A computer implemented system for facilitating access to a plurality of information resources in a computerized environment, the system comprising:
means for collecting data relating to the plurality of information resources and determining relationships among the plurality of information resources wherein the information resources comprise information resources of a plurality of types;
means for determining a current focus of a user, wherein the current focus is an information resource of one of the plurality of types;
means for identifying information resources related to the current focus, the information resources related to the current focus comprising zero or more information resources of each of the plurality of types; and,
means for separately making available for selection by the user the identified information resources of each of the plurality of types.

44. A system according to claim 43 wherein the current focus comprises a focus person and the means for identifying information resources related to the current focus comprises means for identifying files relevant to the focus person, the means for identifying files relevant to the focus person comprising:
means for identifying conversations in which the focus person has participated; and,
means for identifying files attached to messages in the conversations in which the focus person has participated.

45. A system according to claim 44 comprising means for identifying at least one file having a name similar to a name of at least one of the files attached to the messages in the conversations.

46. A system according to claim 43 wherein the current focus comprises a focus person and the means for identifying information resources related to the current focus comprises means for identifying messages relevant to the focus person, the means for identifying messages relevant to the focus person comprising:
means for identifying conversations in which the focus person has participated; and,
means for identifying messages in the conversations in which the focus person has participated.

47. A system according to claim 43 wherein the current focus comprises a focus person and the means for identifying information resources related to the current focus comprises means for identifying persons relevant to the focus person, the means for identifying persons relevant to the focus person comprising:
means for identifying conversations in which the focus person has participated; and,
means for identifying other persons who have participated in the conversations in which the focus person has participated.

48. A system according to claim 43 wherein the current focus comprises a focus file and the means for identifying information resources related to the current focus comprises means for identifying persons relevant to the focus file, the means for identifying persons relevant to the focus file comprising:
means for identifying conversations in which the focus file has been attached to at least one message; and,
means for identifying persons who have participated in the conversations in which the focus file has been attached to at least one message.

49. A system according to claim 43 wherein the current focus comprises a focus file and the means for identifying information resources related to the current focus comprises means for identifying messages relevant to the focus file, the means for identifying messages relevant to the focus file comprising:
means for identifying conversations in which the focus file has been attached to at least one message; and,
means for identifying messages in the identified conversations.

50. A system according to claim 43 wherein the current focus comprises a focus file and the means for identifying information resources related to the current focus comprises means for identifying files relevant to the focus file, the means for identifying files relevant to the focus file comprising:
means for identifying one or more conversations in which the focus file has been attached to at least one message; and,
means for identifying other files which have been attached to at least one message in the identified conversations.

51. A system according to claim 43 wherein the current focus comprises a focus message and the means for identifying information resources related to the current focus comprises means for identifying persons relevant to the focus message, the means for identifying persons relevant to the focus message comprising:
means for identifying a conversation to which the focus message belongs; and,
means for identifying persons who have participated in the identified conversation.

52. A system according to claim 43 wherein the current focus comprises a focus message and the means for identifying information resources related to the current focus comprises means for identifying messages relevant to the focus message, the means for identifying messages relevant to the focus message comprising:
means for identifying a conversation to which the focus message belongs; and,
means for identifying other messages in the identified conversation.

53. A system according to claim 43 wherein the current focus comprises a focus message and the means for identifying information resources related to the current focus comprises means for identifying files relevant to the focus message the means for identifying files relevant to the focus message comprising:
means for identifying a conversation to which the focus message belongs; and,
means for identifying files attached to messages in the identified conversation.

54. A system according to claim 43 comprising means for determining a relevance of each of the information resources to the current focus.

55. A system according to claim 54 wherein the means for determining a relevance of each of the information resources to the current focus comprises means for examining each of a plurality of relationships between the information resource and the current focus, the plurality of relationships including relationships of different types, means for assigning different weights corresponding to the different types of relationships and means for computing a relevance measure for each of the information resources based upon the plurality of relationships and the corresponding weights.

56. A system for determining relationships between information resources in a computerized environment, the system comprising:
a first component for examining data regarding the information resources; and,
a second component for determining explicit relationships between the information resources by examining similarity of data between the information resources.

57. A system according to claim 56 wherein the first component for determining explicit relationships is configured to examine characteristics of the information resources for similarity between the characteristics.

58. A system according to claim 57 wherein the first component for determining explicit relationships is configured to examine the content of the information resources for similarity between the content.

59. A system for determining relationships between information resources in a computerized environment, the system comprising:
a first component for examining data and content regarding the information resources; and
a second component for inferring relationships between information resources by comparing indirect data between the information resources.

60. A system according to claim 59 wherein the first component for inferring relationships between information resources is configured to compare data other than the content of the information resources.

61. A system according to claim 59 wherein the component for inferring relationships between information resources is configured to compare data other than the characteristics of the information resources.

62. A system according to claim 59 wherein the component for inferring relationships between information resources is configured to infer relationships between the information resources based on observations of the information resources.

63. A system according to claim 59 wherein the component for inferring relationships between information resources is configured to infer relationships between the information resources based on attributes about the information resources.

64. A system according to claim 59 wherein the component for inferring relationships between information resources is configured to infer relationships between the information resources based on assumptions of the information resources.
